(19) United States
(12) Patent Application Publication
(10) Pub. No.: US 2002/0114873 A1
(43) Pub. Date: Aug. 22, 2002

(54) Herbal sauce for food, process for preparing the same and product containing the same

(76) Inventor: Tae Yong Lee, Flushing, NY (US)

Correspondence Address: TAE YONG LEE, 144-92 37th Ave., Flushing, NY, 11354, US

(21) Appl. No.: 09/788,799

(22) Filed: Feb. 19, 2001

(51) Int. Cl. A23L 1/238

(52) U.S. Cl. 426/589

(57) ABSTRACT

The present invention relates to an herbal sauce for food prepared by providing an initial mixture of Polygoni Multiflori Radix, Acanthopanacis Cortex, Angelicae Gigantis Radix, Zingiberis Rhizoma, Cinnamomi Cortex Spissus, Glycyrrhizae Radix and Cnidii Rhizoma, soaking the initial mixture in water, heating the initial mixture with the water, filtering the liquified mixture and adding a small amount of garlic powder to the aqueous extract. The present invention also relates to a process for preparing the herbal sauce for food and various products containing the same. The herbal sauce for food of the present invention has a distinctive flavor and aroma obtained by the specific combination of Oriental herbs. The herbal sauce for food of the present invention can be used for various foods and for various applications.

### BACKGROUND OF THE INVENTION

Many kinds of herbs have been used for food and medicine worldwide. From the ancient times, many kinds of Oriental herbs have been widely used for therapeutic and/or health promoting purposes. They have been used individually or combinedly for therapeutic and/or health improvement purposes, in the form of various kinds of medicine, tea, wine, and health food.

Recently, many researches about Oriental herbs have been made with the help of modern medicine. Many researches have revealed the components and efficacy of herbs, and their synergistic effects when mixed and used together. The present invention relates to an herbal sauce for food made from herbs that have been used mainly for therapeutic purposes in traditional Oriental medicine.

Polygoni Multiflori Radix has been used to increase body energies, and to lower plasma cholesterol in traditional Oriental medicine.

Acanthopanacis Cortex (Siberian ginseng) has been used to increase stamina, and to treat neuralgia in traditional Oriental medicine.

Angelicae Gigantis Radix has been used to treat fatigue and menstrual pain, and to sharpen appetite in traditional Oriental medicine.

Zingiberis Rhizoma (ginger) has been used mainly for food and it also has been used to protect the stomach and to sharpen appetite in traditional Oriental medicine.

Cinnamomi Cortex Spissus has been used to protect the stomach, and to reduce fever in traditional Oriental medicine.

Glycyrrhizae Radix has been used to protect the liver, to remove toxin from the body, and to relieve pain in traditional Oriental medicine.

Cnidii Rhizoma has been used to treat menstrual irregularity, menstrual pain and anemia in traditional Oriental medicine.

The above-mentioned herbs have unique flavor and aroma besides their medicinal effects. The above-mentioned herbs have been used individually or combinedly in the forms of medicine, tea, wine, and health food. However, an herbal sauce for food made from the above-mentioned herbs—Polygoni Multiflori Radix, Acanthopanacis Cortex, Angelicae Gigantis Radix, Zingiberis Rhizoma, Cinnamomi Cortex Spissus, Glycyrrhizae Radix and Cnidii Rhizoma—is not known.

The present invention discloses an herbal sauce for food which comprises Polygoni Multiflori Radix, Acanthopanacis Cortex, Angelicae Gigantis Radix, Zingiberis Rhizoma, Cinnamomi Cortex Spissus, Glycyrrhizae Radix and Cnidii Rhizoma. The present invention also discloses a process for preparing the herbal sauce for food and products containing the herbal sauce. The herbal sauce for food of the present invention has a distinctive flavor and aroma obtained by the specific combination of the Oriental herbs. The herbal sauce for food of the present invention can be used for various foods and gives the foods this distinctive flavor and aroma of the Oriental herbs.

### SUMMARY OF THE INVENTION

An object of the present invention is to provide an herbal sauce for food which comprises Polygoni Multiflori Radix, Acanthopanacis Cortex, Angelicae Gigantis Radix, Zingiberis Rhizoma, Cinnamomi Cortex Spissus, Glycyrrhizae Radix, Cnidii Rhizoma and garlic powder.

Another object of the present invention is to provide a process for preparing the herbal sauce for food. This process comprises the steps of:

a) Providing an initial mixture of

about 17 to 23% by weight of Polygoni Multiflori Radix,

about 17 to 23% by weight of Acanthopanacis Cortex,

about 12 to 18% by weight of Angelicae Gigantis Radix,

about 12 to 18% by weight of Zingiberis Rhizoma,

about 7 to 13% by weight of Cinnamomi Cortex Spissus,

about 7 to 13% by weight of Glycyrrhizae Radix and

about 7 to 13% by weight of Cnidii Rhizoma.

b) Soaking the initial mixture in water at least at room temperature for about 30 minutes, wherein the ratio of water to the initial mixture is about 6 liters:1 kg.

c) Heating the initial mixture and the water in a container at about 70° C. to 80° C. for about two hours.

d) Filtering the liquified mixture to produce an aqueous extract.

e) Adding garlic powder to the aqueous extract to produce an herbal sauce, wherein the ratio of garlic powder to the aqueous extract is about 2 grams:1 liter.

Further object of the present invention is to provide products that contain the herbal sauce of the present invention.

### DETAILED DESCRIPTION OF THE INVENTION

The present invention relates to an herbal sauce for food which comprises an aqueous extract of about 17 to 23% by weight of Polygoni Multiflori Radix, about 17 to 23% by weight of Acanthopanacis Cortex, about 12 to 18% by weight of Angelicae Gigantis Radix, about 12 to 18% by weight of Zingiberis Rhizoma, about 7 to 13% by weight of Cinnamomi Cortex Spissus, about 7 to 13% by weight of Glycyrrhizae Radix and about 7 to 13% by weight of Cnidii Rhizoma. The present invention also relates to a process for preparing the herbal sauce for food and products containing the herbal sauce.

In the present invention, Polygoni Multiflori Radix is used. For the best result, the one that is big and has flower patterns of a light red color on the cut-off section and several deep grooves on the surface is preferred.

In the present invention, Acanthopanacis Cortex is used. For the best result, the one that has a deep reddish brown color and is more than 6 years old with rich flavor and aroma is preferred.

In the present invention, Angelicae Gigantis Radix is used. For the best result, the one that is big and has a light yellow color on the cut-off section and a sour taste is preferred.

In the present invention, Zingiberis Rhizoma is used. Zingiberis Rhizoma has been used mainly for food. For the best result, the one that is plump and has a white color on the cut-off section and a strong hot flavor is preferred.

In the present invention, Cinnamomi Cortex Spissus is used. For the best result, the thick one that has a dark pink color on the cut-off section, a very hot and sweet flavor and rich oil is preferred.

In the present invention, Glycyrrhizae Radix is used. For the best result, the one that has a thin peel of a red color, a light yellow color on the cut-off section and a very sweet flavor is preferred.

In the present invention, Cnidii Rhizoma is used. For the best result, the one that is big and has a dark brown color, a sour flavor and a distinctive aroma is preferred.

The color of the herbal sauce of the present invention is light brown. The herbal sauce for food of the present invention can be suitably used in variety of foods. For example, the herbal sauce of the present invention can be used in the preparation of poultry, beef, pork, seafood, vegetables, bread, cake, sauces, marinades, dips, etc. Especially, when the herbal sauce of the present invention is applied to poultry, beef, pork and seafood, it removes the meaty smell or the fishy smell from the meat or the fish and adds the distinctive spicy flavor and aroma obtained by the specific combination of herbs to the meat or the fish, creating a more rich taste. More especially, the herbal sauce of the present invention adds an Oriental flavor and aroma to the foods.

In the following example 1, the process for preparing the herbal sauce of the present invention will be disclosed in detail.

### EXAMPLE 1

A process for preparing the herbal sauce comprises the following steps.

(Step 1) Providing an initial mixture of

about 17 to 23% by weight of Polygoni Multiflori Radix,

about 17 to 23% by weight of Acanthopanacis Cortex,

about 12 to 18% by weight of Angelicae Gigantis Radix,

about 12 to 18% by weight of Zingiberis Rhizoma,

about 7 to 13% by weight of Cinnamomi Cortex Spissus,

about 7 to 13% by weight of Glycyrrhizae Radix and

about 7 to 13% by weight of Cnidii Rhizoma.

(Step 2) Soaking the initial mixture in water at least at room temperature for about 30 minutes, wherein the ratio of water to the initial mixture is about 6 liters:1 kg. This process is needed to get rich flavor and aroma from the initial mixture and to soften the flavor and aroma.

(Step 3) Heating the initial mixture and the water in a container at about 70° C. to 80° C. for about two hours.

In this process, the boiling temperature should be limited to 70° C.-80° C. in order to preserve the distinctive flavor and aroma of the herbs and to prevent the destruction of medicinal components of the ingredients.

(Step 4) Filtering the liquified mixture to produce an aqueous extract.

(Step 5) Adding garlic powder to the aqueous extract and stirring well to produce an herbal sauce, wherein the ratio of garlic powder to the aqueous extract is about 2 grams:1 liter.

In the following example 2, the examples of product containing the herbal sauce according to the present invention will be illustrated without the limitation of the scope of the invention.

### EXAMPLE 2

The herbal sauce for food of the present invention can be used for various foods and gives the hot and sweet flavor and unique aroma obtained by the specific combination of herbs to the foods. Also, for more preferable flavor and aroma of foods according to an individual's taste, the herbal sauce of the present invention may be packaged together with raw herbs of different flavor and aroma—for example, Astragali Radix, Kalopanacis Cortex, Castaneae Semen (peeled chestnut), Zizyphi Fructus (red date), Paeoniae Radix alba, Crataegi Fructus (hawthorn fruit), Shiitake and Lycii Fructus. When using the herbal sauce of the present invention for preparing foods, the user, according to his taste, can add raw herbs packaged together with the herbal sauce to the food and can create flavor and aroma to meet his taste.

Also, the herbal sauce of the present invention may be packaged together with other herbal sauces that are made from herbs of different flavor and aroma—for example, Astragali Radix, Kalopanacis Cortex, Castaneae Semen (peeled chestnut), Zizyphi Fructus (red date), Paeoniae Radix alba, Crataegi Fructus (hawthorn fruit), Shiitake and Lycii Fructus. When preparing the foods, the user can add two kinds of herbal sauces to the foods according to his taste and can create flavor and aroma to meet his taste.

Many variations and modifications will be apparent to those skilled in the art and may be made in combinations, processes, products and procedures of the present invention without departing from the scope and/or spirit thereof. Therefore, the present invention should be limited only by the appended claims.

What is claimed is:

1. An herbal sauce for food comprising the following ingredients:
a) An aqueous extract of
about 17 to 23% by weight of Polygoni Multiflori Radix,
about 17 to 23% by weight of Acanthopanacis Cortex,
about 12 to 18% by weight of Angelicae Gigantis Radix,
about 12 to 18% by weight of Zingiberis Rhizoma,
about 7 to 13% by weight of Cinnamomi Cortex Spissus,
about 7 to 13% by weight of Glycyrrhizae Radix and
about 7 to 13% by weight of Cnidii Rhizoma.
b) Garlic powder.

2. The herbal sauce for food according to claim 1, wherein the herbal sauce for food comprising the following ingredients:
a) An aqueous extract of
about 20% by weight of Polygoni Multiflori Radix,
about 20% by weight of Acanthopanacis Cortex,
about 15% by weight of Angelicae Gigantis Radix,
about 15% by weight of Zingiberis Rhizoma,
about 10% by weight of Cinnamomi Cortex Spissus,
about 10% by weight of Glycyrrhizae Radix and
about 10% by weight of Cnidii Rhizoma.
b) Garlic powder.

3. The herbal sauce of claim 1, wherein the ratio of the garlic powder to the aqueous extract is about 2 grams:1 liter.

4. The herbal sauce of claim 2, wherein the ratio of the garlic powder to the aqueous extract is about 2 grams:1 liter.

5. The herbal sauce of claim 1, further comprising soy sauce, wine, water, sugar, vinegar and salt to form a marinade.

6. The herbal sauce of claim 1, further comprising soy sauce, wine, water, sugar, vinegar and salt to form a barbecue sauce.

7. The herbal sauce of claim 1, further comprising a preservative agent.

8. The herbal sauce of claim 2, further comprising a preservative agent.

9. The herbal sauce of claim 5, further comprising a preservative agent.

10. The herbal sauce of claim 6, further comprising a preservative agent.

11. A process for preparing the herbal sauce of claim 1, comprising the steps of:
(Step 1) Providing an initial mixture of
about 17 to 23% by weight of Polygoni Multiflori Radix,
about 17 to 23% by weight of Acanthopanacis Cortex,
about 12 to 18% by weight of Angelicae Gigantis Radix,
about 12 to 18% by weight of Zingiberis Rhizoma,
about 7 to 13% by weight of Cinnamomi Cortex Spissus,
about 7 to 13% by weight of Glycyrrhizae Radix and
about 7 to 13% by weight of Cnidii Rhizoma.
(Step 2) Soaking the initial mixture in water at room temperature for about 30 minutes, wherein the ratio of water to the initial mixture is about 6 liters:1 kg.
(Step 3) Heating the initial mixture and the water in a container at about 70° C. to 80° C. for about two hours.
(Step 4) Filtering the liquified mixture to produce an aqueous extract.
(Step 5) Adding garlic powder to the aqueous extract to produce an herbal sauce for food of claim 1, wherein the ratio of garlic powder to the aqueous extract is about 2 grams:1 liter.

12. A product containing raw herbs of different flavor and aroma—Astragali Radix, Kalopanacis Cortex, Castaneae Semen (peeled chestnut), Zizyphi Fructus (red date), Paeoniae Radix alba, Crataegi Fructus (hawthorn fruit), Shiitake, Lycii Fructus or a combination thereof—with the herbal sauce of claim 1.

13. A product containing other herbal sauces made from herbs of different flavor and aroma—Astragali Radix, Kalopanacis Cortex, Castaneae Semen (peeled chestnut), Zizyphi Fructus (red date), Paeoniae Radix alba, Crataegi Fructus (hawthorn fruit), Shiitake, Lycii Fructus or a combination thereof—with the herbal sauce of claim 1.
